(19) United States
(12) Patent Application Publication
(10) Pub. No.: US 2015/0052031 A1
(43) Pub. Date: Feb. 19, 2015

(54) SYSTEMS AND METHODS FOR PRESENTING FINANCIAL DATA

(71) Applicants: Susan Strausberg, Austin, TX (US); Marc Strausberg, Austin, TX (US); David Trenck, Oldsmar, FL (US)

(72) Inventors: Susan Strausberg, Austin, TX (US); Marc Strausberg, Austin, TX (US); David Trenck, Oldsmar, FL (US)

(21) Appl. No.: 14/452,231

(22) Filed: Aug. 5, 2014

Related U.S. Application Data
(60) Provisional application No. 61/866,718, filed on Aug. 16, 2013.

(51) Int. Cl. G06Q 40/00; G06F 17/30

(52) U.S. Cl. CPC G06Q 40/12; G06F 17/30864
USPC 705/30

(57) ABSTRACT

Embodiments described herein disclose systems and methods for mapping financial data points to inquiries, wherein responsive to receiving a query, a single financial data point may be presented to a user.

### CROSS-REFERENCE TO RELATED APPLICATIONS

This application claims a benefit of priority under 35 U.S.C. §119 to Provisional Application No. 61/866,718 filed on Aug. 16, 2013, which is fully incorporated herein by reference in its entirety.

### BACKGROUND INFORMATION

1. Field of the Disclosure

Examples of the present disclosure are related to systems and methods for presenting a single data point associated with financial data responsive to receiving a query. More particularly, embodiments disclose mapping data points with queries.

2. Background

A search engine is a software system that is designed to search the internet for information. The search results are generally presented in a line of results, and the results may include a combination of web pages, data, images, or other types of files.

Conventionally, to utilize a search engine, a user creates a query, submits the query, and receives the line of results. However, this process requires that the user perform further research on the set of results to determine the correct answer to their query.

Furthermore, if the set of results includes a plurality of different results presented in different formats with additional information, the user may become inundated with unwanted information, which may or may not be associated with the initial query.

Accordingly, needs exist for more effective and efficient systems and methods for presenting a single data point responsive to receiving a financial query.

### SUMMARY

Embodiments described herein disclose systems and methods for mapping financial data points to queries, wherein responsive to receiving a query for a single financial data point may be presented to a user.

Embodiments may include a client computing devices, a financial server, and data sources. The financial server may be configured to receive financial data, such as balance sheets, income statements, cash flow statements, valuation data, etc. from the data sources. The received financial data may include data points, wherein each data point may be associated with different valuation of financial data, such as a first data point may be associated with a company's assets, a second data point may be associated with a company's liabilities, a third data point may be associated with the company's income, expenses, and/or profits over a period of time. The financial server may also be configured to receive a financial query from a user. In embodiments, the financial query may be a natural language query requesting financial data or selected from a set of options, wherein each option is associated with a different data point.

The financial server may include a data module, a query module, a natural language module, a mapping module, and a presentation module.

The data module may be configured to receive financial data from data sources, and to convert the received financial data into a standardized format. The standardized format may include a database entries associated with each data point, wherein each data point is mapped to a different option.

The query module may be configured to receive financial queries from a user, wherein the queries may be free-form queries and/or selected from a menu, wherein the menu includes a set of options. The natural language processor module may be configured to receive the free-form queries, and determine a corresponding option associated with the query, wherein each option is mapped to a different data point.

The mapping module may be configured to map data points to options, such that responsive to receiving a financial query mapping module may determine a corresponding data point associated with a determined option.

The presentation module may be configured to present the single data point to a user responsive to receiving the financial query.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts one embodiment of a topology for a financial system to present a single data point to a user responsive to receiving a financial query.

FIG. 2 depicts one embodiment of financial server.

FIG. 3 depicts one embodiment of a method for transmitting a single data point responsive to receiving a financial query.

FIG. 4 depicts one embodiment of a screenshot of a financial query.

FIG. 5 depicts one embodiment of a screenshot of a single financial data point being presented in response to a user entering a financial query.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Embodiments described herein disclose systems and methods for mapping financial data points to inquiries, such that responsive to receiving a financial query a single data point is presented to a user. Therefore, the user will not be inundated with unwanted and/or additional information, and save time while reviewing the results of financial queries.

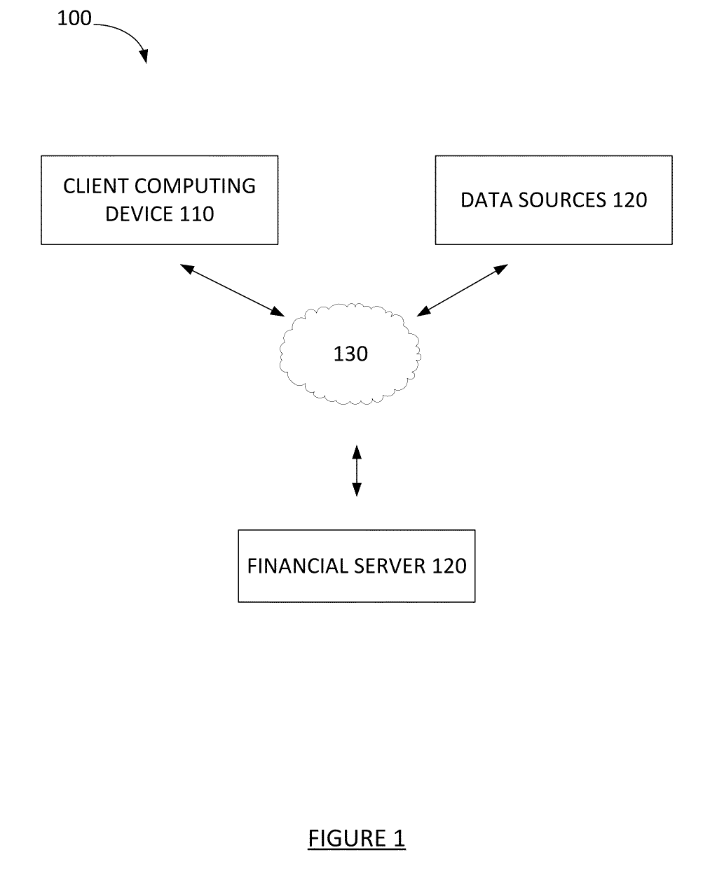

FIG. 1 depicts one embodiment of a topology for a financial system 100 to present a single data point to a user responsive to receiving a financial query. Financial system 100 may include a client computing device 110, data sources 120, financial server 140, and network 130.

Network 130 may be a wired or wireless network such as the Internet, an intranet, a LAN, a WAN, a NFC network, Bluetooth, universal serial bus, infrared, radio frequency, a cellular network, or another type of network. It will be understood that network 130 may be a combination of multiple different kinds of wired or wireless networks.

Client computing device 110 may be a laptop computer, desktop computer, smart phone, tablet computer, personal data assistant, or any other type of device with a hardware processor that is configured to process instructions and connect to network 130 and/or other forms of networks. Client computing device 110 may include a graphical user interface (GUI), a communication device, and a presentation device.

The user interface may be a touch screen, physical keyboard, mouse, camera, video camera, microphone, etc. configured to receive inputs associated with the user's actions. The user's actions may be associated with the user entering a financial query, wherein the financial query may be a free-form query and/or selected from a drop down menu including a set of options. For example, the financial query may be a natural language query, wherein the user types a sentence requesting data, or the financial query may be a selection from a menu, wherein the user selects an option from a dropdown menu to indicate the data the user desires to receive associated with a specific company. The communication device may be configured to transmit the user's financial queries to financial server 140. The presentation device may be configured to present a single financial data point associated with the financial query to the user.

Data sources 120 may be computing devices associated with at least one data source including financial institutions, stock markets, Securities & Exchange Commission filings, etc. Data sources 120 may be configured to transmit financial data, such as balance sheets, income statements, cash flow statements, valuation data, etc. to financial server 140.

Financial server 140 may be a computing device, such as a general hardware platform server configured to support mobile applications, software, and the like executed on client computing device 110 and/or data sources 120. Financial server 140 may include physical computing devices residing at a particular location or may be deployed in a cloud computing network environment. In this description, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Financial server 140 may include any combination of one or more computer-usable or computer-readable media. For example, financial server 140 may include a computer-readable medium including one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device.

In embodiments, financial server 140 may be configured to receive financial data from data sources 120, map data points within the financial data to a lexicon of terms associated with options within a financial query, receive a financial query from client computing device 110, determine an option associated with the query, determine single data point associated with the determined option and the mapping, and transmit the single data point associated with the query to client computing device 110. Therefore, responsive to receiving a financial query, financial server 140 may transmit a single answer to client computing device 120. Accordingly, the user of client computing device 120 may only be presented with the relevant information associated with their question or financial query, and may not be inundated with unwanted information.

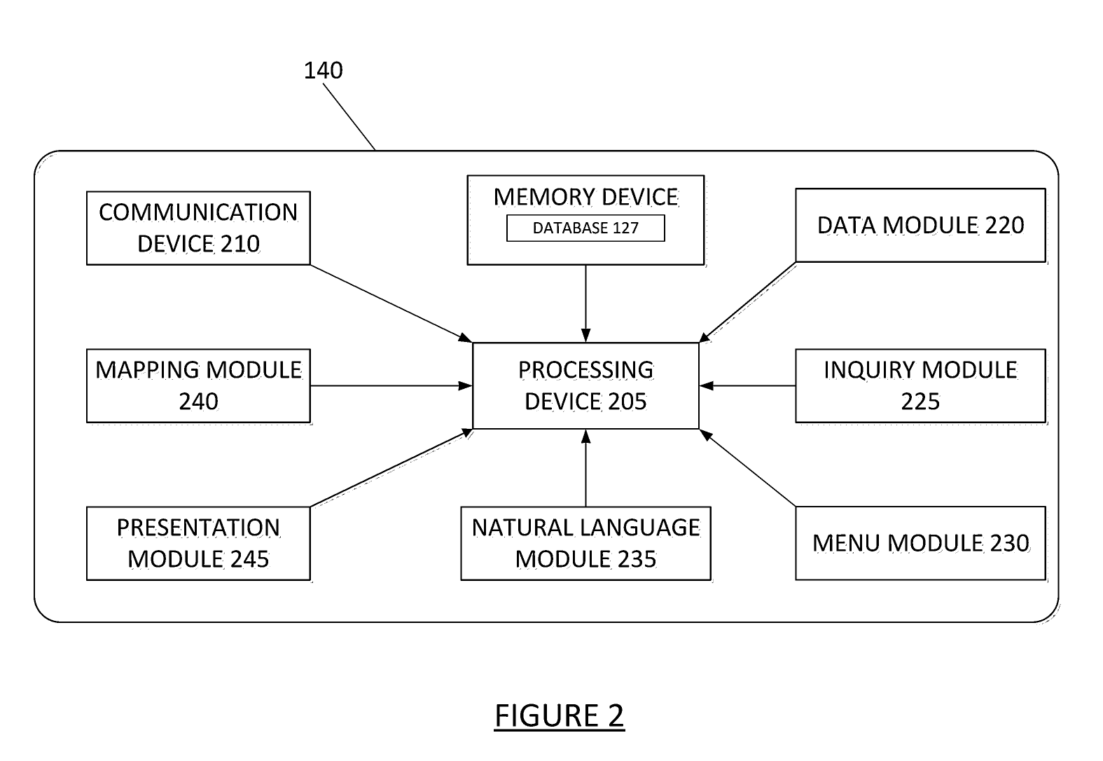

FIG. 2 depicts one embodiment of financial server 140. Financial server 140 may include a processing device 205, a communication device 210, memory device 215, a data module 220, a query module 225, a menu module 230, a natural language module 235, a mapping module 240, and a presentation module 245.

Processing device 205 may include memory, e.g., read only memory (ROM) and random access memory (RAM), storing processor-executable instructions and one or more processors that execute the processor-executable instructions. In embodiments where processing device 205 includes two or more processors, the processors may operate in a parallel or distributed manner. Processing device 205 may execute an operating system of financial server 140 or software associated with other elements of financial server 140.

Communication device 210 may be a hardware processing device that allows financial server 140 to communicate with another device over network 130. Communication device 210 may include one or more wireless transceivers for performing wireless communication and/or one or more communication ports for performing wired communication. In implementations, communication device 210 may be configured to communicate data over a plurality of different standards and/or protocols.

Memory device 215 may be a device that stores data generated or received by financial server 140. Memory device 215 may include, but is not limited to a hard disc drive, an optical disc drive, and/or a flash memory drive. In embodiments, memory device 215 may be configured to store information received from a client computing device 110 and/or data sources 120. The information stored within memory device 215 may be accessed by processing device 205, communication device 210, and/or modules 220, 225, 230, 235, 240, 245. In embodiments, memory device 215 may include a database 217. Database 217 may include entries each with a unique identifier corresponding to different companies. Within an entry for a company may be a plurality of financial data points, wherein the financial data points are associated with different financial data. For example, a first data point may be associated with a number of outstanding shares for the company, a second data point may be associated with earnings per share for the company in a given industry, a third data point may be associated with a dividend yield for the company, etc.

Data module 220 may be a hardware processing device configured to receive financial data from a plurality of data sources 120. Data module 220 may also be configured convert the received financial data into a standardized format. The received financial data may be formatted, such that each quantification of financial data is associated with a single data point within an entry of database 217 for a company. For example, assets, liabilities, equity, income, expenses, etc. may each be a different data points within an entry of database 217 for the company.

Query module 225 may be a hardware processing device configured to receive a financial query from client computing device 110. Query module 225 may include menu module 230 and natural language module 235.

Menu module 230 may be configured to present a drop down menu, checklist, selections, etc. (referred to hereinafter collectively and individually as “drop down menu”) to a user of client computing device 110. Responsive to menu module 230 presenting the drop down menu to the user of client computing device 110, the user may form a financial query by selecting a desired financial data point associated with a company. For example, utilizing menu module 230 the user may select the name of a company, and select from a set of options (e.g. market capitalization, earning to profit ration, etc.) information associated with a financial data point that they desire to view, wherein each of the set of options is associated with a financial data point.

Natural language module 235 may be a natural language processor configured to determine which one of the set of options the user desires to receive information for responsive to a free-from financial data query. Natural language module 235 may include algorithms that are based on machine learning, mappings of terms to options, processing rules, etc. For example, natural language module 235 may be configured to receive a free-form financial data query from client computing device 110, remove stop words from the financial data query, and determine if any of the strings of characters within the financial data query correspond to one of the set of options. For example, if a free-form financial query includes a string of characters of: “What is Microsoft's latest annual quarterly revenue,” then natural language module 235 may determine that the company associate with the inquiry is “Microsoft” and the option that the user desires to receive information for corresponds with “annual quarterly revenue.” One skilled in the art will appreciate that a plurality of terms, abbreviations, symbols may correspond with the same option. For example, the abbreviation “AQR” and the string “annual quarterly revenue” may correspond with the same option. In embodiments, a user of client computing device 110 may be able to set or add string of characters, abbreviations, etc. that correspond with options. Therefore, the user may dynamically set their own lexicon of terms corresponding to different options. Accordingly, two users may have different lexicons of terms that correspond to the same or different options.

Mapping module 240 may be a hardware processing device configured to map the set of options within a financial query to financial data points within database 217. In embodiments, each of the set of options may be mapped to a single financial data point. Responsive to query module 225 determining a company and which one of the set of options is associated with a financial query, mapping module 240 may determine a database entry associated with the company and the data point associated with the selected option. Accordingly, each of the set of options may be mapped to a single financial data point, and responsive to receiving a financial query a single financial data point may be presented to a user based on the mapping.

Presentation module 245 may be a hardware processing device configured to transmit information associated with the single financial data point that is associated with the financial query to client computing device 110. In embodiments, presentation module 245 may transmit a name of the company associated with the financial query and the single financial data point to the user, without sending additional financial data points, links, information, etc.

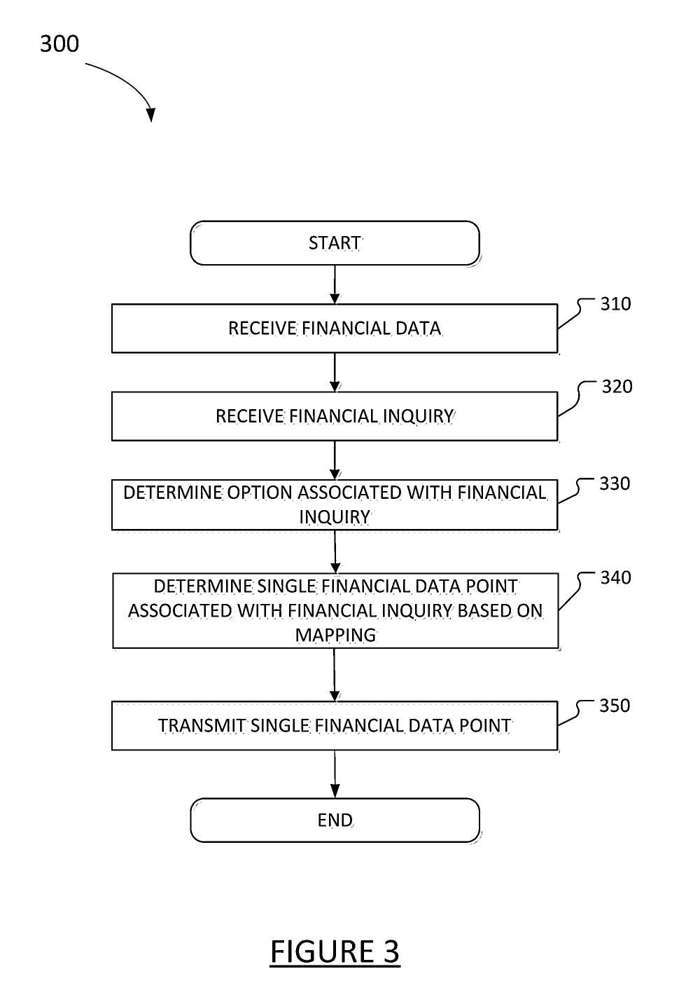

FIG. 3 illustrates a method 300 for transmitting a single data point responsive to receiving a financial query. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

At operation 310, financial data may be received from data sources. The received financial data may be formatted, such that each quantification of financial data is associated with a single data point within an entry of a database for a company. For example, assets, liabilities, equity, income, expenses, etc. may each be a different data points within an entry of the database for the company. Operation 310 may be performed by a data module that is the same as or similar to data module 220, in accordance with one or more implementations.

At operation 320, a financial query may be received. The financial query may be received responsive to a user performing actions to select an option to receive financial data associated with a financial data point for a company. For example, the user may free-form type a financial query to receive the assets associated with a specific company, or select an asset option from a pull down menu. Operation 320 may be performed by a query module that is the same as or similar to query module 225, in accordance with one or more implementations.

At operation 330, responsive to receiving the financial query, an option associated with the financial query may be determined. The option may be determined based on the option being selected from a set of options from a pull down menu, or based on natural language processing on a free-form financial query. Operation 330 may be performed by a query module that is the same as or similar to query module 225, in accordance with one or more implementations.

At operation 340, a financial data point associated with the selected option may be determined. The financial data point may be determined by parsing a mapping of financial data points and options, wherein each of a set of options may correspond with a single, different financial data point within the mapping. Operation 340 may be performed by a mapping module that is the same as or similar to mapping module 240, in accordance with one or more implementations.

At operation 350, single the financial data point associated with the selected option may be transmitted to a client computing device. The financial data point may be transmitted along with the name of the company within the financial query, wherein only a single financial data point is transmitted to the client computing device. Operation 350 may be performed by a presentation module that is the same as or similar to presentation module 245, in accordance with one or more implementations.

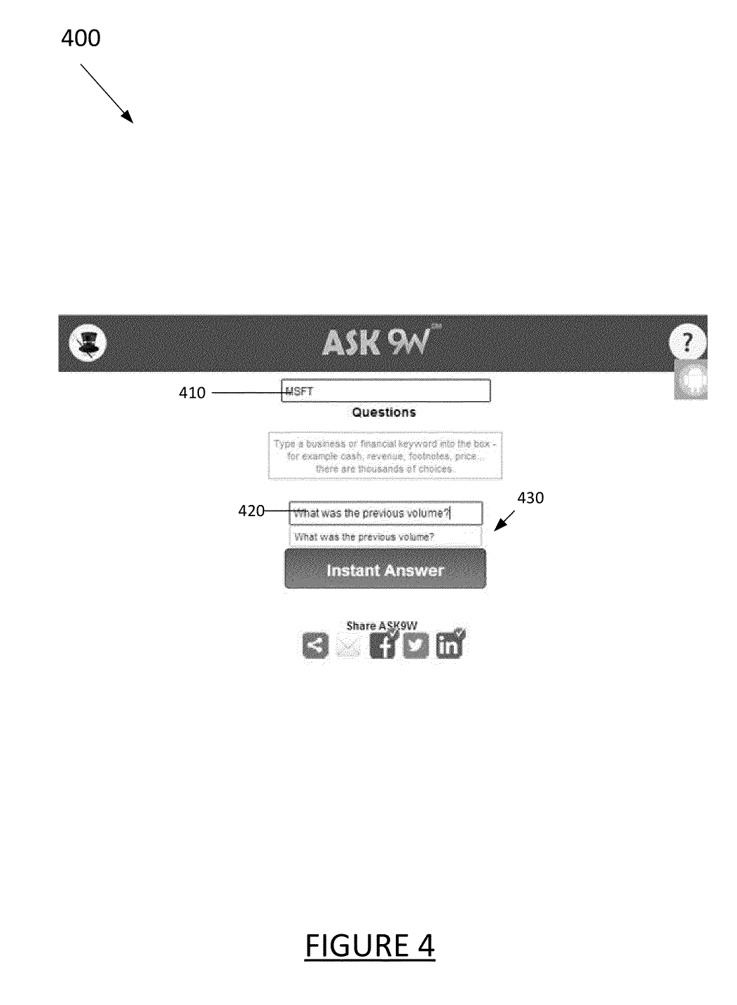

FIG. 4 depicts one embodiment of a screenshot of a financial query 400. Financial query 400 may include a company 410, and may be entered via free-from typing 420 and/or be selected from a drop down menu 430. Responsive to the user performing actions to type a financial query, the user may be presented with different options, wherein each option may be associated with a different financial data point.

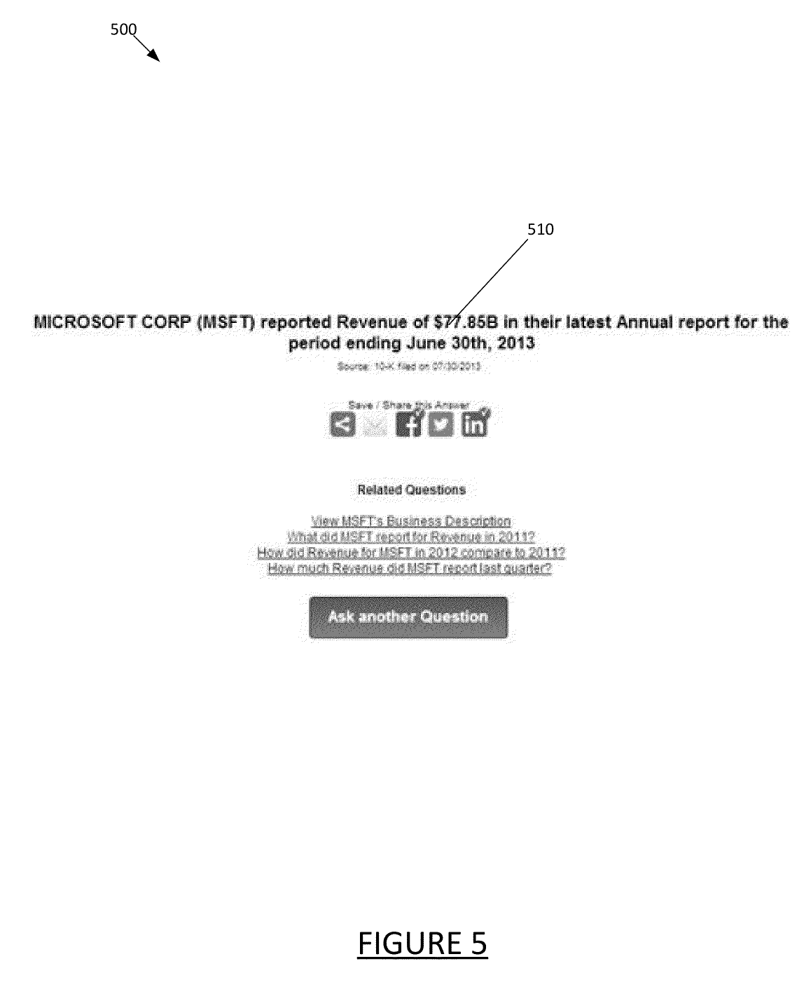

FIG. 5 depicts one embodiment of a screenshot 500 of a single financial data point 510 being presented in response to a user entering a financial query. In embodiments, if the user desires to receive additional financial data associated with different options and/or different financial data points, then it may be required for the user to enter additional financial queries.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present embodiments may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

The flowcharts and block diagrams in the flow diagrams illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowcharts and/or block diagrams.

What is claimed is:

1. A financial data system, the system comprising:
a communication device configured to receive financial data from a plurality of data sources over a network, the financial data including financial data points, and being configured to receive a financial query, the financial query including a selected option within a set of options;
a data module configured to map the financial data points within the financial data to options within the set of options, each of the financial data point being a different quantification of financial data;
a mapping module configured to determine a single financial data point within the financial data that corresponds to the selected option by comparing the selected option with the map; and
a presentation device configured to transmit the single financial data point over the network.

2. The system of claim 1, wherein the different quantifications of financial data includes assets, liabilities, income, expenses, and profits.

3. The system of claim 1, wherein the financial inquiry is associated with a company.

4. The system of claim 3, wherein a different map is generated for different companies.

5. The system of claim 3, wherein the presentation device is configured to transmit a name associated with the company over the network along with the single financial data point.

6. The system of claim 1, wherein the presentation device is configured to only transmit the single financial data point responsive to receiving the financial query, wherein to receive a second financial data point a second financial query is required.

7. The system of claim 1, wherein the financial inquiry is received responsive to the user selecting the selected option from a drop down menu.

8. The system of claim 1, wherein the financial query is received responsive to the user free-form typing a string of characters.

9. The system of claim 8, wherein natural language processing is performed on the string of characters to match the string of characters to the selected option within the set of options.

10. The system of claim 9, wherein a user of a client computing device may dynamically determine strings of characters to correspond with options within the set of options.

11. A financial data method, the method comprising:
receiving financial data from a plurality of data sources over a network, wherein the financial data includes a plurality of financial data points;
receiving a financial query over the network, the financial query including a selected option within a set of options;
mapping the financial data points within the financial data to options within the set of options, each of the financial data point being a different quantification of financial data;
determining a single financial data point within the financial data that corresponds to the selected option by comparing the selected option with the map; and
transmitting the single financial data point over the network.

12. The method of claim 11, wherein the different quantifications of financial data includes assets, liabilities, income, expenses, and profits.

13. The method of claim 11, wherein the financial inquiry is associated with a company.

14. The method of claim 13, wherein a different map is generated for different companies.

15. The method of claim 13, further comprising:
transmitting a name associated with the company over the network along with the single financial data point.

16. The method of claim 11, further comprising:
transmitting a second financial data point responsive to receiving a second financial query, wherein the transmitting the single financial data point responsive to receiving the financial query includes only the single financial data point.

17. The method of claim 11, further comprising:
a user performing actions to enter the financial query and selecting the selected option from a drop down menu.

18. The method of claim 11, further comprising:
a user performing actions to enter the financial query via free-form typing a string of characters.

19. The method of claim 18, further comprising:
performing natural language processing on the string of characters to match the string of characters to the selected option within the set of options.

20. The method of claim 19, further comprising:
dynamically determining, by the user, strings of characters to correspond with options within the set of options.
